(19) United States
(12) Patent Application Publication
(10) Pub. No.: US 2003/0021558 A1
(43) Pub. Date: Jan. 30, 2003

(54) Single optical fiber tight cord

(75) Inventors: Osamu Kato, Chiba (JP); Tsuyoshi Shimomichi, Chiba (JP); Keiji Ohashi, Chiba (JP); Ryoji Suzuki, Chiba (JP); Katsuyoshi Ishida, Gumma (JP); Etsuo Ino, Chiba (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: FUJIKURA LTD., Tokyo (JP)

(21) Appl. No.: 10/198,365

(22) Filed: Jul. 19, 2002

(30) Foreign Application Priority Data
Jul. 19, 2001 (JP) 2001-220324

(51) Int. Cl. G02B 6/44

(52) U.S. Cl. 385/102

(57) ABSTRACT

A single optical fiber tight cord having durable surface which is not cracked even under bending stress is described. The single optical fiber tight cord comprises a optical fiber; a plurality of glass fibers which are located around said optical fiber in parallel with said optical fiber; a UV curable resin provided around said optical fiber together with said glass fibers for fixing said glass fibers around said optical fiber; a UV curable resin layer covering and fixed around said optical fiber; and an outermost layer covering and fixed around said UV curable resin layer and made of a resin which is more excellent than said UV curable resin layer in tractility.

### CROSS REFERENCE TO RELATED APPLICATIONS

This application is based upon and claims the benefit of priority from prior Japanese Patent Application P2001-220324 filed on Jul. 19, 2001; the entire contents of which are incorporated by reference herein.

### BACKGROUND OF THE INVENTION

1. Field of the Invention

The present invention relates to a single optical fiber tight cord composed of one optical fiber which is covered with glass fibers and resin coating.

2. Description of the Related Art

FIG. 1 is a cross sectional view showing an exemplary prior art single optical fiber tight cord. The single optical fiber tight cord has an external diameter of 1.0 mm for example and composed of a optical fiber 103 having a diameter of 0.25 mm protected by 12 glass fibers which are located around the optical fiber 103 in parallel and fixed with a UV curable resin 105B having a Young's modulus of 30 N/mm², and covered with a UV curable resin coating 107 having a Young's modulus of 90 N/mm².

However, in accordance with such a conventional structure, the UV curable resin coating 107 is substantially brittle to have a poor bending stress resistance. Because of this, there is a problem that when the optical fiber cable is connected to a connector 109 by means of an epoxy adhesive and bended at the connection location as illustrated in FIG. 3, a stress is exerted on the UV curable resin coating 107 to generate cracks and break the UV curable resin coating 107, as called edge effects, and therefore it is difficult to surely protect the inside optical fiber 103. Also, the external appearance is impaired.

Furthermore, as illustrated in FIG. 3, since the UV curable resin coating 107 has a poor slip characteristic, it is difficult to pull out one single optical fiber tight cord 101 among from a bundle of a number of similar optical fiber tight cords 101 as connected to the connector 109 because of the frictional force.

### BRIEF SUMMARY OF THE INVENTION

It is an object of the present invention to solve the above described problems and to provide a single optical fiber tight cord having durable surface which is not cracked even under bending stress.

It is another object of the present invention to provide a single optical fiber tight cord which can be easily extracted from a bundle of a number of similar optical fiber tight cords bundle.

In order to accomplish the above described object, a single optical fiber tight cord comprises a optical fiber; a plurality of glass fibers which are located around said optical fiber in parallel with said optical fiber; a UV curable resin provided around said optical fiber together with said glass fibers for fixing said glass fibers around said optical fiber; a UV curable resin layer covering and fixed around said optical fiber; and an outermost layer covering and fixed around said UV curable resin layer and made of a resin which is more excellent than said UV curable resin layer in tractility.

Accordingly, since the external peripheral surface of the single optical fiber tight cord is covered with a resin which is excellent in tractility, there does not occur cracks in the external surface of the single optical fiber tight cord even repeatedly subjected to stress bending stress. As a result, it becomes possible to prevent the light loss from increasing.

In accordance with a preferred embodiment of the present invention, said UV curable resin layer is made of a Nylon12.

Accordingly since the external peripheral surface of the single optical fiber tight cord is covered with a Nylon12 which is excellent in tractility and also has good slip characteristics, there does not occur cracks in the external surface of the single optical fiber tight cord even repeatedly subjected to stress bending stress while it is easy to pull out one single optical fiber tight cord among from a bundle of a number of similar optical fiber tight cords.

In accordance with another aspect of the present invention, a single optical fiber tight cord comprises a optical fiber; a plurality of glass fibers which are located around said optical fiber in parallel with said optical fiber; a UV curable resin provided around said optical fiber together with said glass fibers for fixing said glass fibers around said optical fiber; a UV curable resin layer covering and fixed around said optical fiber; and an outermost layer covering and fixed around said UV curable resin layer and made of a resin which is more excellent than said UV curable resin layer in bending stress resistance.

Accordingly, since the external peripheral surface of the single optical fiber tight cord is covered with a resin which is excellent in tractility, there does not occur cracks in the external surface of the single optical fiber tight cord even repeatedly subjected to stress bending stress. As a result, it becomes possible to prevent the light loss from increasing.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a cross sectional view showing an exemplary prior art single optical fiber tight cord.

FIG. 2 is a schematic diagram showing a conventional problem of cracks occurring in the external surface of a single optical fiber tight cord.

FIG. 3 is a schematic diagram showing the procedure of pulling out one cords among from bundled cords.

FIG. 4 is a cross sectional view showing a single optical fiber tight cord in accordance with an embodiment of the present invention.

FIG. 5 is a schematic diagram showing a measurement system for measuring the frictional force generated when pulling out one single optical fiber tight cord among from a bundle of a number of similar optical fiber tight cords.

FIG. 6 is a schematic diagram showing the system used for carrying out the experiment of counting the number of connector bending cycles.

### DETAILED DESCRIPTION OF THE INVENTION

In the followings, an embodiment of the present invention will be described with reference to the accompanying drawings.

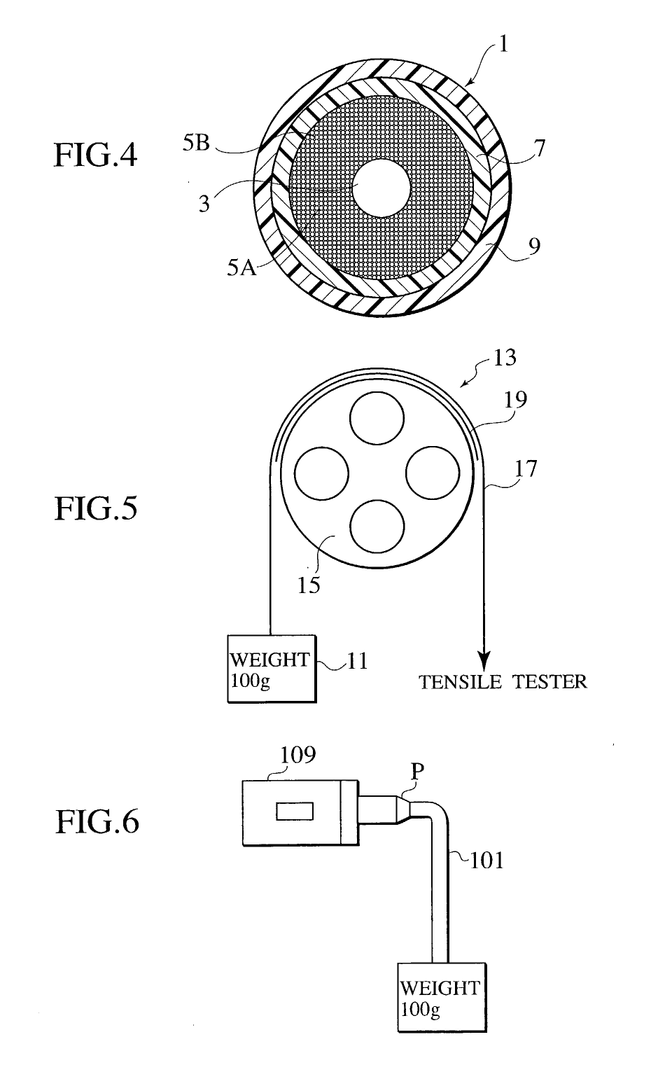

FIG. 4 is a cross sectional view showing a single optical fiber tight cord 1 in accordance with an embodiment of the present invention. The single optical fiber tight cord 1 has an external diameter of 0.9 mm for example and composed of a optical fiber 3 having a diameter of 0.25 mm supported by 12 glass fibers (200 deniers) which are located around the optical fiber 3 in parallel to the optical fiber 3 and fixed with a UV curable resin 5B having a Young's modulus of 30 N/mm², and covered with a UV curable resin coating 7 having a Young's modulus of 50 N/mm². Furthermore, the external surface thereof is covered with a resin coating 9 of 0.1 micrometer thickness as the outermost layer made of a nylon which is excellent in tractility and bending stress resistance, for example, made of Nylon12. Needless to say, while the UV curable resin coating 7 is adhered and fixed to the UV curable resin coating 5B, the outermost layer made of Nylon12 is also adhered and fixed to the UV curable resin coating 7.

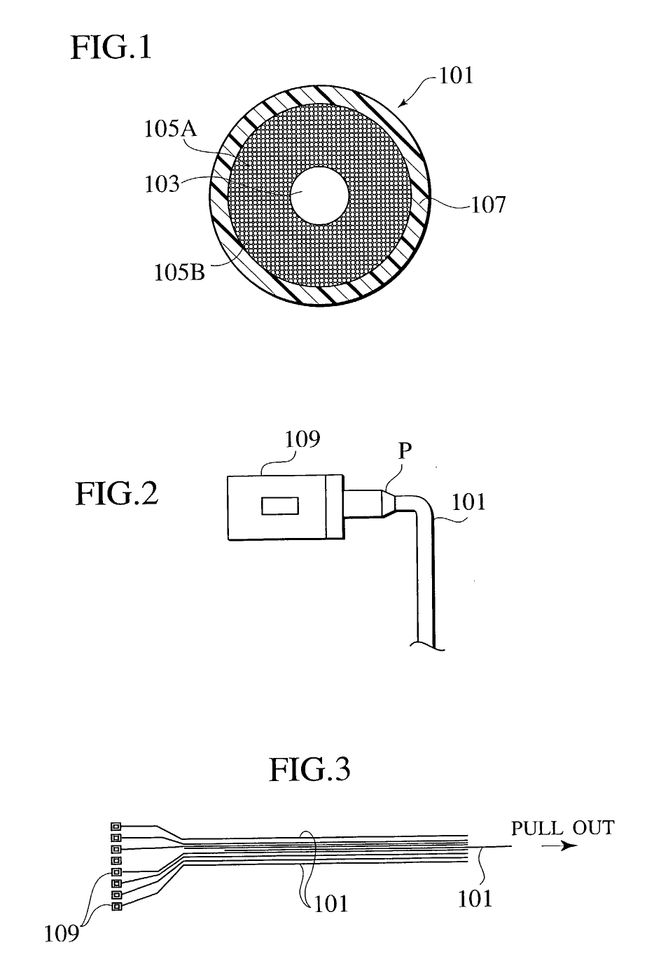

Table 1 describes the results of experiments to compare the case where the outermost layer was made of a UV curable resin as illustrated in FIG. 1 and the case where the outermost layer was made of a nylon coating 9 (Nylon12) as in the single optical fiber tight cord 1 described in the above by counting the number of connector bending cycles before cracking.

TABLE 1

| | | | | | | | Kinetic |
|---|---|---|---|---|---|---|---|
| Outermost | Number of Bending Cycles Before Cracking | | | | | | Friction |
| Layer | 1 | 2 | 3 | 4 | 5 | Average | Force (N) |
| UV Curable | 5 | 4 | 6 | 5 | 3 | 4.6 | 6.7 |
| Resin Coating | | | | | | | |
| Nylon 12 | >50 | >50 | >50 | >50 | >50 | >50 | 3.5 |
| Coating | | | | | | | |

FIG. 6 is a schematic diagram showing the system used for carrying out the experiment of counting the number of bending cycles. Namely, the experiment of counting the number of bending cycles before cracking has been carried out by connecting each single optical fiber tight cord 1(101) of 1 m length at one end to a connector 10 with an adhesive, attaching a 50 g weight 12 to the other end of the single optical fiber tight cord, and repeatedly bending the single optical fiber tight cord 1(101) while counting the number of bending cycles before cracking the outermost layer thereof (the UV curable resin coating 107 or the nylon coating 9). In the case of the outermost layer made of the UV curable resin coating 107 (see FIG. 1), there have been observed cracks after repeating bending for five times on the average. Contrary to this, in the case of the outermost layer made of the nylon coating 9 (Nylon12), there has not been observed any crack even after repeating bending for fifty times.

Also, FIG. 5 is a schematic diagram showing a measurement system for measuring the frictional force generated among single optical fiber tight cords which force is problematic when pulling out one single optical fiber tight cord among from a bundle of a number of similar optical fiber tight cords. The measurement system 13 is equipped with a mandrel 15 to whose external surface are attached a number of optical fiber cords 19 each of which is equivalent to the optical fiber cord 17 under measurement (for example the single optical fiber tight cord 1). The optical fiber cord 17 under measurement is mounted on the mandrel 15 with a 100 g weight 11 attached to one end thereof as illustrated.

With this system, the other end of the optical fiber cord 17 was drawn by means of a tensile tester in order to measure the tensile force applied to the optical fiber cord 17 when the optical fiber cord 17 started to slip off from the optical fiber cord 19. As a result, as described in Table 1, in the case where the outermost layer was made of the nylon coating 9 (Nylon12) as in the single optical fiber tight cord 1 in accordance with the present invention, the tensile force was about 3.5 N which was about half the tensile force measured in the case where the outermost layer was made of the UV curable resin 107 (see FIG. 2) and therefore it was confirmed that the coefficient of sliding friction is substantially reduced by the present invention.

With the above experiments in mind, it is understood that the bending stress resistance can be improved by covering a single optical fiber tight cord with the nylon coating (Nylon12) as the outermost layer to effectively prevent occurrence of cracks. Also, a nylon coating (Nylon12) has good slip characteristics so that it is possible to easily pull out one cords among from closely bundled cords.

The foregoing description of preferred embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated. For example, while the nylon coating 9 is made of Nylon12 in the case of the embodiment as described above, other nylons or other suitable resins can be used for the same purpose. For example, while the nylon coating 9 is made of Nylon12 in the case of the embodiment as described above, other nylons or other suitable resins can be used for the same purpose. Namely, thermoplastic elastmer polymer (TPEE) is excellent in tractility and in bending stress resistance, and therefore can be used for the same purpose as Nylon12.

Meanwhile, the term “tight” is used in this embodiment to express the structure that the respective constituent layers including the optical fiber itself can substantially not move relative to each other within the single optical fiber tight cord structure. Namely, it is possible to bundle a number of such single optical fiber tight cords in order to allow relative movement to each other while each single optical fiber tight cord maintains the inside solid structure as being tight.

What is claimed is:

1. A single optical fiber tight cord comprising:
a optical fiber;
a plurality of glass fibers which are located around said optical fiber in parallel with said optical fiber;
a UV curable resin provided around said optical fiber together with said glass fibers for fixing said glass fibers around said optical fiber;
a UV curable resin layer covering and fixed around said optical fiber; and
an outermost layer covering and fixed around said UV curable resin layer and made of a resin which is more excellent than said UV curable resin layer in tractility.

2. The single optical fiber tight cord as claimed in claim 1 wherein said UV curable resin layer is made of a Nylon12.

3. A single optical fiber tight cord comprising:
a optical fiber;
a plurality of glass fibers which are located around said optical fiber in parallel with said optical fiber;
a UV curable resin provided around said optical fiber together with said glass fibers for fixing said glass fibers around said optical fiber;
a UV curable resin layer covering and fixed around said optical fiber; and
an outermost layer covering and fixed around said UV curable resin layer and made of a resin which is more excellent than said UV curable resin layer in bending stress resistance.

4. The single optical fiber tight cord as claimed in claim 3 wherein said UV curable resin layer is made of a Nylon12.
